(19) United States
(12) Patent Application Publication
(10) Pub. No.: US 2024/0392067 A1
(43) Pub. Date: Nov. 28, 2024

(54) PROCESS FOR SYNTHESISING POLYEPICHLOROHYDRIN

(71) Applicant: EURENCO, Sorgues (FR)

(72) Inventors: Geneviève ECK, Vedene (FR); Thibaud ALAIME, Vedene (FR); Sergei KOSTJUK, Minsk (BY); François GANACHAUD, Villeurbanne (FR); Guy JACOB, Vert-le-Petit (FR)

(73) Assignee: EURENCO, Sorgues (FR)

(21) Appl. No.: 18/694,314

(22) PCT Filed: Sep. 21, 2022
(86) PCT No.: PCT/FR2022/051773

§ 371 Date: Mar. 21, 2024

(30) Foreign Application Priority Data
Sep. 21, 2021 (FR) FR2109891

(51) Int. Cl. C08G 65/24

(52) U.S. Cl. CPC C08G 65/24; C08G 2650/22

(57) ABSTRACT

A method for synthesising polyepichlorohydrin includes: a) reacting epichlorohydrin with boron trifluoroetherate in the presence of a solvent; b) adding epichlorohydrin to the reaction product obtained in step a); c) hydrolysing the product obtained in step b).

### FIELD OF THE INVENTION

The invention relates to the field of energetic materials. More specifically, the invention concerns a process for synthesizing a polyglycidyl azide intermediate, namely polyepichlorohydrin.

### STATE OF THE ART

With the aim of increasing the ballistic performance of tactical and strategic missiles, more energetic materials have been developed, in particular using glycidyl polyazide (GPA) to replace the inert binders historically used, such as polybutadienehydroxytelechelic (PBHT).

GPA can be produced in two stages, as shown in Scheme 1 below, from epichlorohydrin (ECH) via polyepichlorohydrin (PECH), which is a dihydroxytelechelic polymer.

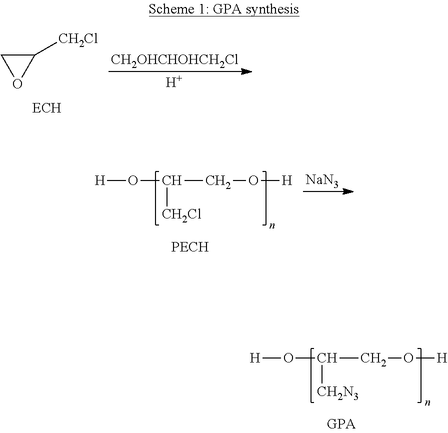

In the literature, there are three main methods of polymerising ECH to obtain PECH:
coordination polymerisation;
cationic polymerisation;
anionic polymerisation.

### Coordination Polymerisation

Catalytic ring-opening polymerisation of ECH was first described by Vandenberg [1-4] to synthesise PECHs with high molecular weights (Mn≥50,000 g·mol⁻¹).

More recently other active species have been described such as bis(μ-oxo)dialkylaluminum [5]. Several other monometallic [6-8] and bimetallic catalyst systems have also been described, but again for the synthesis of high molecular weight PECHS.

Generally speaking, coordination polymerisation has a number of drawbacks from the point of view of understanding the mechanisms involved:
unsophisticated catalytic systems and polymerisation procedures;
no data on polydispersity, functionality or structure;
polymerisation mechanism unknown.

A more recent publication describes the solvent-free polymerisation of ECH in the presence of a specific catalyst [Zn—Co(III) DMCC: “Zinc cobalt (III) double metal cyanide complex”] as described in scheme 2 below. Yields ranged from 30 to 84% for number average weights of 900 g·mol⁻¹ to 4,200 g·mol⁻¹ with, however, a high polydispersity of the order of 1.5.

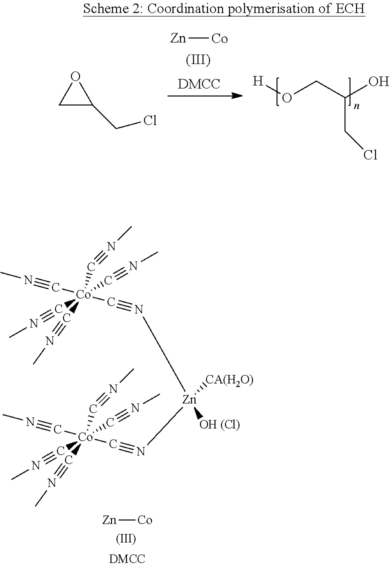

### Anionic Polymerisation

The controlled anionic polymerisation of ECH in the presence of Oct₄NBr/(iBu)₃Al as initiator has been described by Carloti [11-12]. It has a number of advantages, including the use of a non-chlorinated solvent such as toluene. However, it also has one major drawback, which is the production of a monohydroxyl polymer, as shown in scheme 3 below.

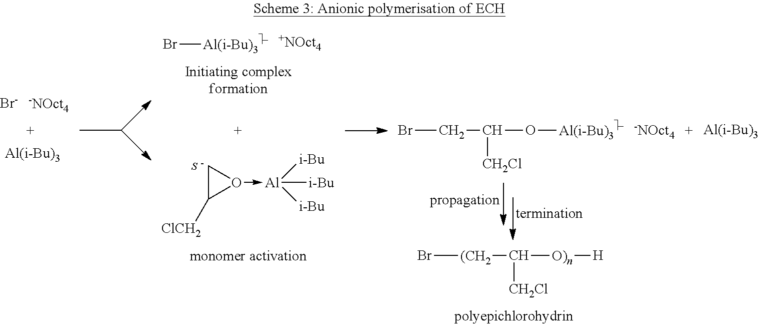

Very recently, direct polymerisation of glycidyl azide has been carried out using triethylborane combined with tetrabutylammonium bromide as a catalyst [13].

### Cationic Polymerisation

The data in the literature clearly show that coordination polymerisation and anionic polymerisation are not suitable for the synthesis of PECH, mainly because of a lack of control of the molecular weight and functionality which is very often far from the target value: 2.

In contrast, cationic ring-opening polymerisation with a diol as initiator leads to a dihydroxytelechelic polymer as shown in scheme 4.

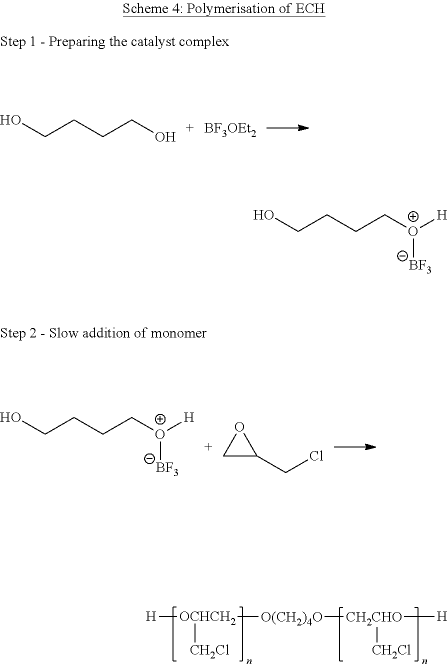

Polymerisation is often carried out in the presence of Lewis acids, such as boron trifluoroetherate (BF₃OEt₂) [14-18], tin tetrachloride (SnCl₄) [19], triethyloxonium hexafluorophosphate (Et₃O⁺PF⁶⁻) [20], 1,4-butanediyl ditriflate [21]. Triethyloxonium hexafluorophosphate leads to low molecular weight PECHs (Mn<1,000 g·mol⁻¹), while butanediyl ditriflate leads to higher molecular weight PECHs (between 3,500 and 15,000 g·mol⁻¹) but in low yields.

Boron trifluoroetherate and tin tetrachloride are the most widely used, often combined with a diol as an initiator, with boron trifluoroetherate providing less polydisperse polymers than those obtained with tin tetrachloride.

Two patent applications [22,23] also describe the production of PECH by cationic polymerisation.

The solvents most commonly used for ECH polymerisation are chlorinated solvents, such as methylene chloride or 1,2-dichloroethane (DCE). The use of such solvents is affected by European regulation 1907/2006, better known as REACH (Registration, Evaluation, Authorisation and Restriction of Chemicals), which lists the substances whose use is subject to authorisation. For example, DCE has been included in Annex XIV of the REACH regulation since 14 Aug. 2014, and can no longer be used in the absence of authorisation since 22 Nov. 2017. The obsolescence of DCE, and of other chlorinated solvents, is therefore foreseeable in the short to medium term.

Replacing chlorinated solvents in PECH synthesis therefore involves finding alternative synthesis routes that are compatible with current environmental and toxicological regulations, while maintaining the characteristics (number average mass Mn, weight average mass Mw and hydroxyl content) of the polymers currently produced and used on an industrial scale.

There are certainly examples of solvent-free cationic polymerisation of ECH described in the literature. The first example is the polymerisation of ECH in the presence of Bronsted acids such as acid clays [24]. In this case, polymerisation is carried out solvent-free but the polymer obtained is bimodal, with a low molecular weight and a significant presence of cyclic by-products. In the second example, the reaction takes place in the presence of paratoluenesulphonic acid and tin tetrachloride. However, a major problem with this solvent-free route is the risk of losing control of the reaction.

The possibility of obtaining PECH in a non-chlorinated solvent was investigated using butanediol as a polymerisation initiator and boron trifluoroetherate as a catalyst. However, this butanediol/boron trifluoroetherate system has several drawbacks:
a large quantity of catalyst is required to reduce the exothermicity of the reaction;
there is an induction period followed by a “spontaneous” rise in temperature, which is sometimes difficult to control;
competition between butanediol and the residual water present in the reagents, leading to the formation of a PECH with high polydispersity and above all sub-optimal functionality, indicating the presence of macrocycles within the polymer.

None of the processes described in the literature is therefore really satisfactory in terms of current regulations. Those that could be considered acceptable with regard to these regulations have low yields or lead to polymers whose physico-chemical characteristics are not in line with those of polymers currently produced on an industrial scale.

There is therefore a need for an alternative synthesis of PECH that is more environmentally friendly, compatible with current regulations, and that does not alter the physico-chemical properties of this product. It was with these specifications in mind that the present invention was developed.

### SUMMARY OF THE INVENTION

The invention relates to a process for the synthesis of polyepichlorohydrin which comprises:
a) the reaction of epichlorohydrin with boron trifluoroetherate in the presence of a polymerisation initiator and optionally a non-chlorinated solvent;
b) the addition of epichlorohydrin to the reaction product obtained in step a);
c) the hydrolysis of the product obtained in step b).

### DETAILED DESCRIPTION OF THE INVENTION

In the context of the present disclosure, the expression “reaction product” has the usual and common meaning used in chemical synthesis, namely a product which results from the reaction between at least two reagents which interact and are transformed into said product. Thus, the expression “reaction product obtained in step x” is equivalent to the expression “product obtained at the end of step x”. It will be further noted that when a process described in the present disclosure comprises a plurality of steps, each step is distinct. Thus, if a process comprises a step a) and a step b) involving “the reaction product obtained in step a)”, it goes without saying for those skilled in the art that step b) cannot begin until step a) has been completed, i.e. the reagents have been consumed to form the “reaction product from step a)”.

The invention relates to a process for synthesising polyepichlorohydrin which implements cationic polymerisation of epichlorohydrin by ring opening according to a so-called “activated monomer” mechanism. In this mechanism, shown in scheme 5, the chain ends are neutral and propagation takes place via nucleophilic attack of a hydroxyl group on the oxonium ion present in the monomer, thus forming only a linear diol PECH.

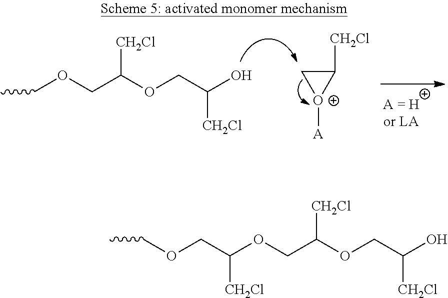

In order to control the molar weight of PECH, the polymerisation essentially proceeds as a two-step process:
step 1: initiation of polymerisation in the presence of epichlorohydrin, boron trifluoroetherate, a polymerisation initiator and optionally a non-chlorinated solvent;
step 2: polymerisation by controlled addition of epichlorohydrin.

The polymerisation termination phase proceeds in the conventional way in the presence of water.

Thus, the present invention relates to a process for the synthesis of polyepichlorohydrin which comprises:
a) the reaction of epichlorohydrin with boron trifluoroetherate in the presence of a polymerisation initiator and optionally a non-chlorinated solvent;
b) the addition of epichlorohydrin to the reaction product obtained in step a);
c) the hydrolysis of the product obtained in step b).

In some embodiments, the polymerisation initiator is water, butanediol or 3-chloro-1,2-propanediol, preferably water.

In some embodiments, step a) is carried out in the absence of solvent.

In some embodiments, step a) is carried out in the presence of a non-chlorinated solvent.

Advantageously, the non-chlorinated solvent is toluene, acetonitrile or nitromethane, preferably toluene.

In some embodiments, the polymerisation initiator and epichlorohydrin are used in substantially equimolar quantities in step a).

In some embodiments, the polymerisation initiator is used in excess relative to boron trifluoroetherate in step a).

In some embodiments, epichlorohydrin is used pure or in a solvent in step b). In some embodiments, said solvent is identical to that used in step a).

In some embodiments, epichlorohydrin is added in one or several stages in step b).

In some embodiments, the reaction of step a) is controlled to obtain an epichlorohydrin oligomer having a degree of polymerisation (DPn) greater than or equal to 4. When the oligomer of DPn≥4 is isolated at the end of step a), step b) may further comprise the addition of boron trifluoroetherate.

The process according to the invention is compatible with a scale-up (pilot and/or industrial scale). Indeed, this process makes it possible to obtain polyepichlorohydrin on a scale of a hundred grams (see examples 4 and 6) without degrading the characteristics of the polymer in terms of Mn, polydispersity and functionality, or any risk associated with the exothermicity of the reaction.

To sum up, the synthesis process of the invention allows very good control of polymerisation and has many advantages:
control, or even elimination, of the temperature exotherm often observed during ring-opening cationic polymerisation;
polymerisation carried out between 20° C. and 40° C. in a non-chlorinated solvent, in the presence of water;
polymerisation time (about 5 to 6 hours) compatible with industrial scale;
polymerisation yields in excess of 90%, or even quantitative, and therefore comparable to the yields obtained on an industrial scale, which are of the order of 95%;
obtaining a monomodal polymer with perfectly controlled Mn (from 500 to 4,100 g·mol⁻¹) having an exceptionally high functionality of 2.00±0.05, thus in line with theory, to be compared with a functionality of 1.4 to 1.6 for a PECH produced, to date, on an industrial scale;
low polydispersity, less than or equal to 1.25, which is therefore comparable to the values measured on an industrial PECH.

The invention will be better understood with the aid of the following examples, given by way of illustration. In these examples, the number average molar mass (Mn) and weight average molar mass (Mw) of polyepichlorohydrin were determined either by NMR or by steric exclusion chromatography (SEC) using the following apparatus:

### NMR

¹H NMR (500 MHZ) in CDCl₃ at 25° C. on a Bruker AC-500;
¹³C NMR (125 MHZ) in DMSO-d6 on a Bruker AC-500.

### SEC

equipment: Ultimat 3000 Thermo Scientific with an Agilent PLgel 5 μm MIXED-C column (300×7.5 mm) and a precolumn (PL gel 5 μm 50λ7.5 mm) thermostated at 30° C.;
detection: refractometry and UV;
eluent: THF, 1.0 ml/min;
standard: polystyrene.

The polydispersity Ð of polyepichlorohydrin is equal to the ratio Mw/Mn.

The functionality is calculated according to the formula: [Mn(SEC)/Mn(NMR)]×2.

The formulae BF₃O(C₂H₅)₂ and BF₃OEt₂ are used interchangeably to designate boron trifluoroetherate (also known as boron trifluoride dietherate).

### Example 1

a) 0.48 mL (6.12×10⁻³ mol) of ECH, 0.046 mL (3.72×10⁻⁴ mol) of BF₃O(C₂H₅)₂ and 0.1 mL (5.56×10−3 mol) of H₂O were placed in a round-bottom flask. The reaction mixture was stirred at 25° C. for 1.5 h until a clear viscous liquid formed. A mixture of 11.3 mL (0.15 mol) of ECH and 5.65 mL of toluene was then added via a syringe pump, controlling the rate of addition to control the exothermicity of the reaction.

b) After complete addition of the ECH, the reaction mixture was stirred for 1 h, then hydrolysed by the addition of 2 to 3 mL of distilled water. The reaction medium was diluted with toluene (about 5 mL), washed with about 50 ml of an aqueous sodium bicarbonate solution (5% by weight) and several times with distilled water (about 50 mL in total) until the washing phases were neutral. The solvent was evaporated under vacuum on a rotary evaporator and the polyepichlorohydrin obtained was dried under vacuum at 60° C. to constant weight.

Yield ≥97%; Mn (NMR)=2500 g·mol⁻¹; Mn (SEC)=2600 g·mol⁻¹; Ð=1.1/1.2; Functionality=2.

### Example 2

The procedure of Example 1 was repeated using 12.7 mL (0.17 mol) of ECH, 0.054 mL (0.44×10−3 mol) of BF₃OEt₂ and 1.84 mL (6.54×10−3 mol) of 3-chloro-1,2-propanediol.

Yield=94%; Mn (NMR)=2340 g·mol⁻¹; Mn (SEC)=2370 g·mol⁻¹; Ð=1.20; Functionality=2.

### Example 3

The procedure of Example 1 was repeated using pure ECH instead of ECH in solution in toluene in the second part of step a).

Yield=99-100%; Mn (NMR)=2270 g·mol⁻¹; Mn (SEC)=2270 g·mol⁻¹; Ð=1.23; Functionality=2.

### Example 4

3.2 mL (4.08×10−2 mol) of ECH, 0.33 mL (2.71×10−3 mol) of BF₃OEt₂, 3.2 mL of toluene and 0.73 mL (4.05×10−2 mol) of H₂O were placed in a round-bottom flask. The reaction mixture was stirred for 1.5 h at 25° C. until a clear viscous liquid formed. A mixture of 80.7 mL (1.03 mol) of ECH and 37 mL of toluene was then added to the flask in two stages, the rate of addition being controlled each time to control the exothermicity of the reaction. The cumulative addition time of the ECH solution was approximately 9 h. Once the ECH solution had been added, the reaction mixture was stirred again for 1 h and then hydrolysed. Washing and recovery of the polyepichlorohydrin were carried out according to the procedure of Example 1.

Yield=97%; Mn (NMR)=2430 g·mol⁻¹; Mn (SEC)=2580 g·mol⁻¹; Ð=1.18; Functionality=2.

### Example 5

An ECH oligomer was prepared from 12.8 mL (4.08×10−2 mol) of ECH, 0.33 mL (2.71×10⁻³ mol) of BF₃OEt₂, 15.4 mL of toluene and 0.73 mL (4.05×10−2 mol) of H₂O, with stirring for 4 h. The product obtained had the following characteristics:

Yield=85%; Mn (SEC)=622 g·mol⁻¹; Mn (NMR)=425 g·mol⁻¹: Ð=1.09; DPn=4.

A polymerisation reactor was then charged with 12.64 g (2.97×10−2 mol) of the ECH oligomer, 37 mL of toluene and 0.27 mL (2.19×10−3 mol) of BF₃OEt₂. The reaction medium was stirred for 1 h, then 71 mL (0.91 mol) of ECH were added to the reactor. The reaction medium was again stirred for 1 h and then hydrolysed. Washing and recovery of the polyepichlorohydrin were carried out according to the procedure of Example 1.

Yield=99%; Mn (NMR)=2500 g·mol⁻¹; Mn (SEC)=2800 g·mol⁻¹; Ð=1.21; Functionality=2.

### Example 6

3.2 mL (4.08×10−2 mol) of ECH, 0.32 mL (2.69×10−3 mol) of BF₃OEt₂, 3.2 mL of toluene and 0.7 mL (3.85×10−2 mol) of H₂O were placed in a round-bottom flask. The reaction mixture was stirred for 1.5 h. 78 mL (1.00 mol) of ECH was then added in two stages to the flask, controlling the rate of addition each time to control the exothermicity of the reaction. The cumulative ECH addition time was about 8 h. Once the ECH solution had been added, the reaction mixture was stirred again for 0.5 h and then hydrolysed. Washing and recovery of the polyepichlorohydrin were carried out according to the procedure of Example 1.

Yield=99%; Mn (NMR)=2490 g·mol⁻¹; Mn (SEC)=2820 g·mol⁻¹; Ð=1.21; Functionality=2.

### REFERENCES

1) Vandenberg, E. J. Award Address, Polymer 1994, 35, 4933-4939
2) Vandenberg, E. J. Organometallic Catalysts for Polymerizing Monosubstituted Epoxides. J. Polym. Sci. 1960, 47, 486-489
3) Vandenberg, E. J. Epoxide Polymers: Synthesis, Stereochemistry, Structure, and Mechanism. J. Polym. Sci. Part A: Polym. Chem. 1969, 7, 525-567
4) Brochu, S.; Ampleman, G. Synthesis and Characterization of Glycidyl Azide Polymers Using Isotactic and Chiral Poly(epichlorohydrin)s. Macromolecules 1996, 29, 5539-5545.
5) Ferrier Jr, R. C.; Pakhira, S.; Palmon, S. E.; Rodriguez, C. G.; Goldfeld. D. E.; Iyiola, O. O.; Chwatko, M.; Mendoza-Cortes, J. L.; Lynd, N. A. Demystifying the Mechanism of Regio- and Isoselective Epoxide Polymerization Using the Vandenberg Catalyst. Macromolecules 2018, 51, 1777-1786.
6) Masuda, Y.; Hani, H. Organoaluminum-Cyclic Ether-Cyclic Imide Catalysts for the Polymerization of Epoxides. J. Polym. Sci.: Polym. Chem. Ed. 1973, 11, 3103-3114.
7) Araki, T.; Aoyagi, T.; Ueyama, N.; Aoyama, T.; Tani, H. Ethylaluminum Oxide Catalysts from Et₂AlOLi-Et₂AlCl Binary System in Relation to Species of AlEt3-Water Catalyst. J. Polym. Sci. Part A: Polym. Chem. 1973, 11, 699-712;
8) Xie, H-Q.; Guo, J-S.; Yu, G.-Q.; Zu, J. Ring-Opening Polymerization of Epichlorohydrin and its Copolymerization with other Alkylene Oxides by Quaternary Catalyst System. J. Appl. Polym. Sci. 2001, 80, 2446-2454.
9) Kuntz, I.; Kroll, W. R. Polymerization of Epoxides with Dialkylaluminum Acetylacetonate Catalyst Systems J. Polym. Sci. part A: Polym. Chem. 1970, 8, 1601-1621.
10) Rodriguez, C. G.; Ferrier Jr, R. C.; Helenic, A.; Lynd, N. A. Ring-Opening Polymerization of Epoxides: Facile Pathway to Functional Polyethers via a Versatile Organoaluminum Initiator. Macromolecules 2017, 50, 3121-3130.
11) Carlotti, S.; Labbe, A.; Rejsek, V.; Doutaz, S.; Gervais, M.; Deffieux, A. Living/Controlled Anionic Polymerization and Copolymerization of Epichlorohydrin with Tetraoctylammonium Bromide-Triisobutylaluminum Initiating Systems. Macromolecules 2008, 41, 7058-7062.
12) Brocas, A-L.; Cendejas. G.; Caillol, S.; Deffieux, A.; Carlotti, S. Controlled Synthesis of Polyepichlorohydrin with Pendant Cyclic Carbonate Functions for Isocyanate-Free Polyurethane Networks. J. Polym. Sci. Part A: Polym. Chem. 2011, 49, 2677-2684
13) Boopathi, S. K.; Hadjichristidis, N.; Gnanou, Y.; Feng, X. Direct Access to Poly(glycidyl azide) and its Copolymers through Anionic (Co-)Polymerization of Glycidyl Azide. Nature Communications 2019, 10, 293.
14) Bideron, T.; Kubisa, P.; Penczek, S. Polyepichlorohydrin Diols Free of Cycles: Synthesis and Characterization. J. Polym. Sci. Part A: Polym. Chem. 1991, 29, 619-628
15) Panda, S. P.; Sahu, S. K.; Thakur, J. V.; Kulkarni, S. G.; Kumbhar, C. G.; Sadafule, D. S. Synthesis and Characterization of Hydroxyl Terminated Polyepichlorohydrin and Polyglycidylazide. Def. Sci. J. 1996, 46, 399-403.
16) Kim, J. S.; Kweon, J. O.; Noh, S. T. Online Monitoring of Reaction Temperature during Cationic Ring Opening Polymerization of Epichlorohydrin in Presence of BF3 and 1,4-Butanediol. J. Appl. Polym. Sci. 2014, 131, 39912
17) Guanaes, D.; Bittencourt, E.; Eberlin, M. N.; Sabino, A. A. Influence of Polymerization Conditions in the Molecular Weight and Polydispersity of Polyepichlorohydrin. Eur. Polym. J. 2007, 43, 2141-2148
18) Grinevich, T. V.; Solov'yanov, A. A.; Vinogradov, D. B.; Bulatov, P. V.; Kuznetsov, G. P.; Assovskii, I. G.; Berlin, A. A.; Tartakovskii, V. A. Oligo (glycidyl azides): New Approaches to Synthesis and Properties. Dokl. Chem. 2014, 454, 39-41
19) Francis, A. U.; Venkatachalam, S.; Kanakavel, M.; Ravindran, P. V.; Ninan, K. N. Structural Characterization of Hydroxyl Terminated Polyepichlorohydrin Obtained using Boron Trifluoride Etherate and Stannic Chloride as Initiators. Eur. Polym. J. 2003, 39, 831-841.
20) Okamoto, Y. Cationic Ring-Opening Polymerization of Epichlorohydrin in the Presence of Ethylene Glycol. ACS Symp. Ser. 1985, 286, 361-372
21) Kim, C. S.; Kuo, K.; Fish, R.; Russell, J.; Curb, P.; Immoos, J. Telechelic Polymerization of Epichlorohydrin using 1,4-Butanediyl Ditriflate as the Initiator. Macromolecules 1990, 23, 4715-4717
22) FR 2 638 751 A1
23) FR 2 633 300 A1
24) Yahiaoui, A.; Belbachir, M.; Hachemaoui, A. An Acid Exchanged Montmorillonite Clay-Catalyzed Synthesis of Polyepichlorhydrin. Int. J. Mol. Sci. 2003, 4, 548-561
25) Muhammad Ahmad, Muhammad Sirajuddin, Zareen Akther, Waqar Ahmad, Spectrochim. Acta Part A: Mol. Biomol. Spectro. 2015, 151, 164-173

1. A process for the synthesis of polyepichlorohydrin which comprises:
a) the reaction of epichlorohydrin with boron trifluoroetherate in the presence of a polymerisation initiator, in the absence of solvent or in the presence of a non-chlorinated solvent;
b) the addition of epichlorohydrin to the reaction product obtained in step a);
c) the hydrolysis of the product obtained in step b).

2. The process of claim 1, wherein the polymerization initiator is water or 3 chloro-1,2-propanediol.

3. The process of claim 1, wherein the non-chlorinated solvent is toluene.

4. The process of claim 1, wherein the reaction of step a) is carried out in the presence of equimolar amounts of polymerisation initiator and epichlorohydrin.

5. The process of claim 1, wherein the reaction of step a) is carried out in the presence of an excess of polymerisation initiator relative to boron trifluoroetherate.

6. The process of claim 1, wherein in step b) epichlorohydrin is used pure or in a solvent.

7. The process of claim 1, wherein epichlorohydrin is added in one or more stages in step b).

8. The process of claim 1, wherein the reaction is controlled in step a) to obtain an epichlorohydrin oligomer having a degree of polymerisation greater than or equal to 4.

9. The process of reaction 8, wherein the oligomer obtained in step a) is isolated and step b) further comprises the addition of boron trifluoroetherate to said isolated oligomer.
